(19) United States
(12) Patent Application Publication
(10) Pub. No.: US 2023/0106636 A1
(43) Pub. Date: Apr. 6, 2023

(54) TRACKING MEMORY TRANSACTIONS MATCHING SPECIFIED PATTERN

(71) Applicant: Hewlett-Packard Development Company, L.P., Spring, TX (US)

(72) Inventors: Gary T. Brown, Boise, ID (US); Vincent C. Skurdal, Boise, ID (US); John Harris, Boise, ID (US)

(21) Appl. No.: 17/492,432

(22) Filed: Oct. 1, 2021

(51) Int. Cl. G06F 13/16; G06F 3/06

(52) U.S. Cl. CPC G06F 13/1668; G06F 3/0655; G06F 3/061; G06F 3/0673; G06F 2213/16

(57) ABSTRACT

Secure circuitry detects a number of memory transactions matching a specified pattern on a bus between a processor external to the secure circuitry and a memory external to the secure circuitry. The secure circuitry detects a cumulative size of the memory transactions matching the specified pattern on the bus between the processor and the memory. In response to either or both of the number of the memory transactions being outside a number range and the cumulative size being outside a size range, the secure circuitry performs an action.

### BACKGROUND

Computing devices include general-purpose computing devices as well as application-specific computing devices. General-purpose computing devices include desktop, laptop, notebook, and server computers, as well as smartphones, tablet computing devices, and other types of computing devices. Application-specific computing devices are also referred to as embedded systems, and are devices designed to perform dedicated functions, either as independent systems or as part of larger systems. Embedded systems can be implemented in conjunction with peripheral devices, such as printing and other types of devices, as well as devices as disparate as kitchen appliances, automotive electronics, network cameras, and so on.

Both general-purpose and application-specific computing devices often have network connectivity, permitting them to be globally connected with other computing devices via the Internet. While such interconnectedness has resulted in services and functionality almost unimaginable in the pre-Internet world, not all the effects of the Internet have been positive. A downside, for instance, to having a computing device potentially reachable from nearly any other device around the world is the computing device's susceptibility to malicious cyber attacks that likewise were unimaginable decades ago. Computing devices are also susceptible to cyber attack even if not connected to the Internet or another network.

### BRIEF DESCRIPTION OF THE DRAWINGS

FIG. 1 is a diagram of an example computing device including an integrated circuit (IC) having secure circuitry to tracking memory transactions matching specified patterns.

FIGS. 2A, 2B, and 2C are diagrams of specific example attribute lines, pattern attribute value registers, and pattern attribute mask registers, respectively.

FIGS. 3A and 3B are flowcharts of an example method for tracking memory transactions matching specified patterns.

FIG. 4 is a diagram of an example non-transitory computer-readable data storage medium storing program code executable by the secure circuitry of FIG. 1 to tracking memory transactions matching a specified pattern.

FIG. 5 is a flowchart of an example method performed by the secure circuitry of FIG. 1 to tracking memory transactions matching a specified pattern.

### DETAILED DESCRIPTION

As noted in the background, computing devices include general-purpose computing devices as well as application-specific computing devices that are also referred to as embedded systems. Both types of computing devices can be susceptible to cyber attacks to cause the devices to perform impermissible functionality, to otherwise compromise the devices to impermissibly access data stored by the devices, and so on. That a computing device has been compromised may be indicated via unexpected processor access of memory.

As a processor of a computing device executes applications, the processor accesses memory over a memory bus. The processor may retrieve different amounts of data from and store different amounts of data to different memory locations. That is, the processor may read different amounts of data from and may write different amounts of data to different locations of the memory.

If a nefarious party has compromised the security of a computing device, a processor may access certain memory locations more often than expected, and may retrieve or store more data than expected at these or other memory locations. Particularly in an embedded system, the processor may ordinarily run defined applications in accordance with which the processor has expected memory access behavior. If the memory access behavior of the processor deviates from the expected behavior, then this may indicate that the computing device has been compromised. The application that the processor is running may have been maliciously altered, for instance, or the processor may be running nefarious applications that it is not expected to execute.

Techniques described herein track memory transactions that match specified patterns via secure circuitry of an integrated circuit (IC) of the computing device. A memory transaction is a read or write access by a processor of an amount of memory at a specified memory location. A pattern specifies a memory address range and memory access attributes. Memory access attributes can include the size (i.e., amount) of data that is accessed, among other types of attributes.

The secure circuitry detects or tracks the number of memory transactions that match the specified patterns. The secure circuitry also detects or tracks the cumulative size of such transactions (i.e., the cumulative amount of memory accessed by the transactions). If the number of transactions matching a specified pattern is greater than a maximum number of transactions, or the cumulative size of the transactions is greater than a maximum size, then an action can be performed as a result of the computing device having potentially been compromised.

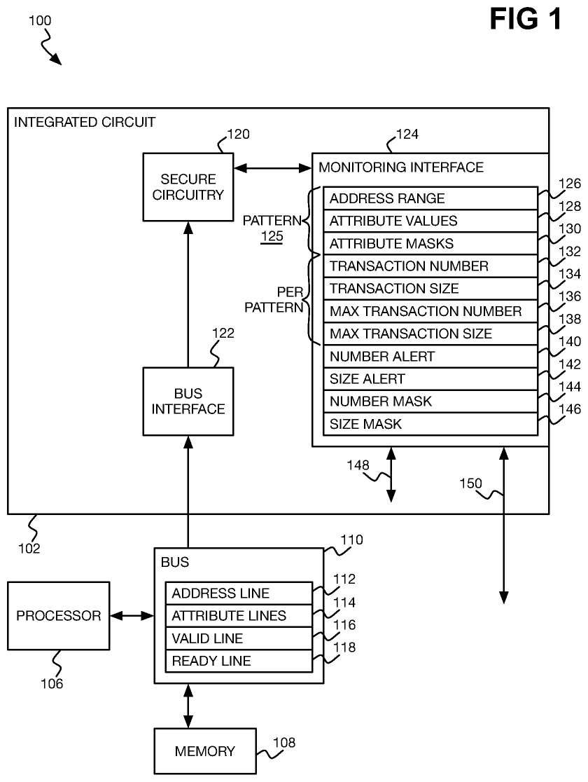

FIG. 1 shows an example computing device 100. The computing device 100 may be a general-purpose computing device, or the device 100 may be an application-specific computing device (i.e., an embedded system). The computing device 100 includes an IC 102. The computing device 100 also includes a processor 106, a memory 108, and a memory bus 110 external to the IC 102. The computing device 100 can include other components external to the IC 102, in addition to the processor 106 and the memory 108.

The IC 102 is security hardened in that the IC 102 is securely isolated from other components of the device 100, such as the processor 106, the memory 108, and the memory bus 110, and is inaccessible to such components except via provided interfaces of the IC 102. The processor 106 may be a general-purpose processor, such as a reduced-instruction set computing (RISC) architecture processor like an ARM processor in one implementation. The memory 108 may be dynamic random-access memory (DRAM).

The memory bus 110 is the bus via which the processor 106 accesses the memory 108, and in one implementation may be an advanced extensible interface (AXI) bus in the case in which an ARM processor is being employed. The memory bus 110 may also be an AXI bus even if an ARM processor is not being used. The memory bus 110 may be a read memory bus over which data is retrieved from the memory 108, a write memory bus over which data is stored in the memory 108, or a combined read-and-write memory bus. The memory bus 110 can include lines 112, 114, 116, and 118.

Specifically, the memory bus 110 can include a multiple-bit address line 112. The address line 112 has a number of bits corresponding to the architecture of the computing device 100, such as the architecture of the processor 106 and the memory 108, and specifies the maximum amount of memory 108 that is addressable by the processor 106. For example, for an architecture having a 16-bit addressable memory space, the address line 112 has 16 bits, and the processor 106 can access 2¹⁶=65,536 different memory locations. For an architecture having a 32-bit addressable memory space, the address line 112 has 32 bits, and the processor 106 can access 2³²=4,294,967,296 different memory locations.

The memory bus 110 can include one or multiple attribute lines 114. Each attribute line 114 can correspond to a different memory access attribute, and has a number of bits corresponding to the number of different attribute values of the attribute in question. For example, if an attribute line 114 has 3 bits, then the attribute line 114 can specify any of 2³=8 different attribute values. An example of the attribute lines 114 in an implementation in which the memory bus 110 is an AXI bus, such that the corresponding attributes are specified by the AXI bus protocol, is described later in the detailed description.

In one implementation, the memory bus 110 can include valid and ready lines 116 and 118. The valid and ready lines 116 and 118 are handshake lines, and can be one-bit lines. When the ready line 118 is raised high (i.e., set to one), the memory bus 110 is ready to receive specification of a new memory transaction via setting of the address line 112 and the attribute lines 114. The valid line 116 is raised high (i.e., set to one) to indicate that the memory transaction specified on the address line 112 and the attribute lines 114 is a valid memory transaction.

In operation, the processor 106 waits until the ready line 118 is raised, and then specifies the memory address to be accessed within a memory transaction on the address line 112 and the attributes describing the memory access on the attribute lines 116. The values written to the address line 112 and the attribute lines 114 define the memory transaction. The processor 106 then raises the valid line 116 to indicate that the memory transaction specified on the lines 112 and 114 is valid, such that the processor 106 accesses the memory 108 in accordance with the memory transaction.

The IC 102 includes secure circuitry 120, a memory bus interface 122, and a monitoring interface 124. The secure circuitry 120 may be in the form of an application-specific IC (ASIC) that is integrated within the IC 102. The secure circuitry 120 is secure at least in that it is part of the IC 102 that is securely isolated from components of the computing device 100 external to the IC 102.

The memory bus interface 122 is the interface by which the IC 102 interconnects with the memory bus 110 to monitor access of the memory 108 by the processor 106. That is, the bus interface 122 is the interface by which the IC 102 monitors memory transactions on the bus 110, which can also be referred to as bus snooping or bus sniffing. The memory bus interface 122 is an input interface, in that the IC 102 can monitor memory transactions on the memory bus 110, but cannot provide information on the bus interface 122 or otherwise write to interface 122. The secure circuitry 120 is communicatively connected to the memory bus interface 122. In another implementation, the monitoring interface 124 may be part of the secure circuitry 120.

The monitoring interface 124 is the interface by which the IC 102 provides information as to tracking of memory transactions by the secure circuitry 120, and by which the IC 102 receives information as to how such tracking is to be performed. The secure circuitry 120 is bidirectionally communicatively connected to the monitoring interface 124, and can read from and write to the interface 124. The monitoring interface 124 has a number of registers 126, 128, 130, 132, 134, 136, 138, 140, 142, and 146, some of which are single-bit and others of which are multiple-bit registers, and some of which are read-only and others of which are write-only or read-and-write registers from the perspective of the secure circuitry 120. In another implementation, the monitoring interface 124 may be part of the secure circuitry 120.

Specifically, the registers 126, 128, and 130 define or specify a pattern 125 of memory transactions that the secure circuitry 120 is to track. There may be multiple different patterns 125 of memory transactions to be tracked, such that there are corresponding registers 126, 128, and 130 for each pattern 125. For each pattern 125, a component within the IC 102 or a component external to the IC 102 sets the registers 126, 128, and 130 to define the pattern 125 in question. The registers 126, 128, and 130 may be considered read-only registers from the perspective of the secure circuitry 120, in that the circuitry 120 can read the registers 126, 128, and 130 but may not write to the registers 126, 128, and 130.

For each pattern 125, the monitoring interface 124 thus includes an address range register 126. The address range register 126 is a multiple-bit register, and can have twice the number of bits of the architecture of the processor 106 and the memory 108. For example, if the architecture has a 16-bit addressable memory space, then the register 126 may have 32 bits, and if the architecture has a 32-bit addressable memory space, then the register 126 may have 64 bits.

The address range register 126 defines the range of memory addresses of the pattern 125 in question, from a lowest memory address of the range to a highest memory address of the range. As one example, if the address range register 126 has 32 bits, then the lower 16 bits may specify the lowest memory address of the range of the pattern 125. The upper 16 bits thus specifies the highest memory address of the range of the pattern 125. For a memory transaction on the memory bus 110 to match the pattern 125, the transaction has to specify a memory address on the address line 112 falling within (i.e., inside) the address range of the register 126.

For each pattern 125, the monitoring interface 124 includes one or multiple attribute value registers 128 and one or multiple attribute mask registers 130. There is a pair of an attribute value register 128 and an attribute mask register 130 for each attribute line 114 of the memory bus 110. The registers 128 and 130 corresponding to an attribute line 114 each have a number of bits equal to the number of bits of the attribute line 114 in question. The attribute value and the attribute mask define a memory access attribute of the pattern 125 in question. For a memory transaction on the memory bus 110 to match the pattern 125, the transaction has to specify an attribute on each attribute line 114 that match the attribute of the corresponding attribute value register 128-attribute mask register 130 pair.

The memory access attribute defined by an attribute value register 128-attribute mask register 130 pair can employ logical AND, OR/NOR, XOR/XNOR, or NAND matching, as well as another technique, such as by using a multiplexer. An example is specifically described as to using logical AND matching in this respect, but other implementations can use a different type of logic matching or another technique. In a logical AND matching approach, the attribute on an attribute line 114 may thus match the attribute of the corresponding attribute value register 128-attribute mask register 130 pair as follows.

A logical AND operation may be performed on (the bits of) the attribute line 114 and (corresponding bits of) the corresponding attribute mask register 130. A logical AND operation may also be performed on (the bits of) this attribute mask register 130 and (corresponding bits of) the corresponding attribute value register 128. If the results of the two logical AND operations match, then the memory transaction has an attribute on the attribute line 114 in question that matches the attribute of the corresponding attribute value register 128-attribute mask register 130 pair.

For example, an attribute line 114 may have 6 bits, such that the corresponding attribute value register 128 and the corresponding attribute mask register 130 also each have 6 bits. A pattern 125 may specify that for a memory transaction to match the pattern 125, the second through fourth bits (starting from the rightmost bit) have to be 1, 0, and 1, respectively. By comparison, whether the first, fifth, and sixth bits of the memory transaction are each 0 or 1 does not impact whether the transaction matches the pattern 125.

The second through fourth bits of the attribute value register 128 of the pattern 125 are therefore set to 1, 0, and 1. The other bits of the register 128, which do not impact whether a memory transaction matches the pattern 125, are set to 0. The attribute value register 128 is therefore set to 0x001010.

By comparison, the second through fourth bits of the attribute value mask register 130 of the pattern are set to 1, 1, and 1. That is, the bits of the register 130 that impact whether a memory transaction matches the pattern are each set to 1. The other bits of the register 130, which do not impact whether a memory transaction matches the pattern 125, are set to 0. The attribute value mask register 130 is therefore set to 0x001110.

The logical AND of the attribute value register 128 and the attribute value mask register 130 in the example is 0x001010, which is equal to the attribute value register 128. Therefore, in one implementation, instead of performing a logical AND operation on the registers 128 and 130, the register 128 is used.

Memory transactions having attributes on the attribute line 114 of 0x111011, 0x101010, and 0x001011 all have second through fourth bits on the line 114 that are set to 1, 0, and 1. The logical AND of the attribute line 114 and the attribute value mask register 130 for each of these transactions is 0x001010, and thus matches the logical AND of the registers 128 and 130. Therefore, such memory transactions potentially match the pattern 125.

By comparison, memory transactions having attributes on the attribute line 114 of 0x111111, 0x0100011, and 0x0001111 do not have second through fourth bits on the line 114 that are set to 1, 0, and 1. The logical AND of the attribute line 114 and the attribute value register 130 for these transactions is 0x001110, 0x000010, and 0x0001110, respectively, none of which matches the logical AND of the registers 128 and 130. Therefore, such memory transactions do not match the pattern 125.

For each pattern 125, the monitoring interface 124 can also include a transaction number register 132 and a transaction size register 134. The registers 132 and 134 are read-and-write registers from the perspective of the secure circuitry 120. By comparison, other components of the IC 102 and/or components external to the IC 102 may be able to read but not write the registers 132 and 134. The register 132 for a pattern 125 stores the number of memory transactions matching the pattern 125. The register 134 for a pattern 125 stores the cumulative size of memory transactions matching the pattern 125.

Each transaction number register 132 is thus a multiple-bit register that has a sufficient number of bits to store the maximum number of transactions matching the corresponding pattern 125 that the secure circuitry 120 can maximally track. For example, if the register 132 is a 16-bit register, then the circuitry 120 can track up to 2¹⁶=65,536 transactions matching the corresponding pattern 125. Once the maximum trackable number of transactions has been reached, the register 132 may saturate (i.e., remain at the maximum number), or roll over. When a memory transaction on the memory bus 110 matches a pattern 125 (as defined by the registers 126, 128, and 130), the corresponding transaction number register 132 is incremented.

Each transaction size register 134 is similarly a multiple-bit register that has a sufficient number of bits to store the cumulative size of the memory transactions matching the corresponding pattern 125 that the secure circuitry 120 can maximally track. For example, if the register 134 is a 32-bit register, then the circuitry 120 can track memory transactions matching the corresponding pattern 125 that have a cumulative size of up to 2³²=4,294,967,296. Once the maximum trackable cumulative size has been reached, the register 134 may saturate or roll over. When a memory transaction on the memory bus 110 matches a pattern 125 (as defined by the registers 126, 128, and 130), the corresponding transaction size register 134 is increased by the size of the transaction (i.e., the amount of data accessed by the transaction).

For each pattern 125, the monitoring interface 124 can further include a maximum transaction number register 136 and a maximum transaction size register 138. For example, if there are sixteen patterns 125, then there are sixteen registers 136 and sixteen registers 138. In another implementation, however, there may be just one register 136 and one register 138 for all the patterns 125. The registers 132 and 138 are multiple-bit registers that each have a sufficient number of bits to respectively store the number of transactions matching a pattern 125 and the cumulative size of such transactions.

The maximum transaction number register 136 for a pattern 125 stores the maximum permitted number of memory transactions matching the pattern 125. That is, the maximum number of memory transactions for a pattern 125 is the maximum number of memory transactions matching the pattern 125 that the processor 106 is expected or permitted to assert on the memory bus 110. The maximum transaction size register 138 for a pattern 125 stores the maximum permitted cumulative size of memory transactions matching the pattern 125. That is, the maximum permitted cumulative size of memory transactions for a pattern 125 is the maximum cumulative size of memory transactions matching the pattern 125 that the processor 106 is expected or permitted to assert on the memory bus 110.

If the number of transactions matching a pattern 125 exceeds its corresponding maximum number of transactions, or if the cumulative size of the transactions matching a pattern 125 exceeds its corresponding maximum cumulative size, then the secure circuitry 120 may provide an alert to indicate the potential of security compromise of the computing device 100. The sensor circuitry 120 may issue a number alert for a pattern 125 if the corresponding maximum number of memory transactions is exceeded or a size alert for a pattern 125 if the corresponding maximum cumulative size of the memory transactions is exceeded, for instance.

The registers 136 and 138 may be read-only registers from the perspective of the secure circuitry 120, and may be read-and-write registers from the perspective of other components of the IC 102 and/or components external to the IC 102. For example, a component of the IC 102 other than the secure circuitry 120, or a component external to the IC 102, may specify the maximum permitted number of transactions matching each pattern 125 before the secure circuitry 120 is to issue a number alert, by writing this value to the corresponding register 136. Similarly, such a component may specify the maximum permitted size of transactions matching each pattern 125 before the circuitry 120 is to issue a size alert, by writing this value to the corresponding register 138.

The monitoring interface 124 can include number and size alert registers 140 and 142 and number and size alert mask registers 144 and 146. The registers 140, 142, 144, and 146 are each a multiple-bit register having a number of bits corresponding to the patterns 125. The alert registers 140 and 142 store alerts that the secure circuitry 120 has triggered. If the maximum number of transactions matching a pattern 125 has been exceeded, the secure circuitry 120 may thus set a corresponding bit of the number alert register 140. If the maximum cumulative size of the transactions matching a pattern 125 has been exceeded, the secure circuitry 120 may set a corresponding bit of the size alert register 142. The alert registers 140 and 142 are read-and-write registers from the perspective of the secure circuitry 120, and may be able to be read but not written by other components of the IC 102 and/or components external to the IC 102.

The number and size alert mask registers 144 and 146 store alert masks indicating the patterns 125 for which the secure circuitry 120 is to report latency and interval alerts, respectively. If a number alert is to be reported for a pattern 125 when the corresponding maximum number of transactions matching the pattern 125 has been exceeded, a bit of the number alert mask register 144 is set to one (i.e., high). If a size alert is to be reported for a pattern 125 when the corresponding maximum cumulative size of the memory transactions matching the pattern 125 has been exceeded, a bit of the size alert mask register 146 is set to one (i.e., high).

The alert registers 140 and 142 are thus respectively masked by the alert mask registers 144 and 146. Even if a bit of the number alert register 140 corresponding to a pattern 125 is set, masking of the register 140 with the latency alert mask register 144 will not result in reporting of a number alert for the pattern 125 if the corresponding bit of the register 144 is not set. Similarly, even if a bit of the size alert register 142 corresponding to a pattern 125 is set, masking of the register 142 with the size alert mask register 146 will not result in reporting of a size alert for the pattern 125 if the corresponding bit of the register 146 is not set. The alert mask registers 144 and 146 may be read-and-write registers from the perspective of components of the IC 102 other than the secure circuitry 120 and/or from the perspective of components external to the IC 102, and may be able to be read but not written by the circuitry 120.

The secure circuitry 120 is bidirectionally communicatively connected to the monitoring interface 124 in that the circuitry 120 can read from and/or write to various of the registers 126, 128, 130, 132, 134, 136, 138, 140, 142, and 146. There may also be bidirectional communicative connection between the monitoring interface 124 and other components internal to the IC 102, as indicated by bidirectional arrow 148. Similarly, there may be bidirectional communicative connection between the monitoring interface 124 and components external to the IC 102, as indicated by the bidirectional arrow 150.

By triggering alerts on the alert registers 140 and 142 as respectively masked by the alert mask registers 144 and 146, for instance, the secure circuitry 120 can cause actions to be performed to resolve issues causing the processor 106 to impermissibly access the memory 108 over the memory bus 110. As examples, an application being run on the computing device 100 may have its execution terminated, paused, or restarted, or the device 100 itself may be restarted.

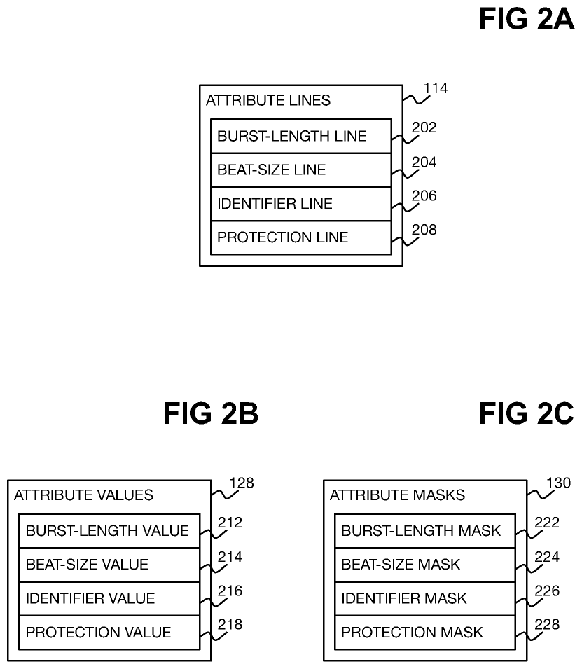

FIG. 2A shows a specific example of the attribute lines 114 in an implementation in which the memory bus 110 is an AXI memory bus, such that memory transactions on the bus 110 conform to the AXI protocol. FIGS. 2B and 2C respectively show corresponding specific examples of the attribute value registers 128 and the attribute mask registers 130 for each pattern 125 in such an implementation in which the memory bus 110. The attribute lines 114 include lines 202, 204, 206 and 208, such that the attribute value registers 128 include corresponding registers 212, 214, 216, and 218 for each pattern 125 and the attribute mask registers 130 include corresponding registers 222, 224, 226, and 228 for each pattern 125.

The burst-length line 202 is a multiple-bit line having a number of length bits corresponding to a burst length of a memory transaction on the memory bus 110. The burst length of a transaction is an encoded value that indicates the number of data beats for the current transaction. The beat-size line 204 is a multiple-bit line having a number of size bits corresponding to a beat size of the memory transaction. The beat size of a transaction is an encoded version of the number of bytes being transferred for the current transaction. The lines 202 and 204 may also be respectively referred to as AWLEN and AWSIZE lines in the case in which the memory bus 110 is a write bus, and as ARLEN and ARSIZE lines in the case in which the bus 110 is a read bus.

The lines 202 and 204 specify the size of a memory transaction (i.e., the amount of data being accessed by the transaction). For example, the size of a transaction may be (BURST+1)×(1<<BEAT), where BURST is the burst length, BEAT is the beat size, and <<is the bit shift-left operator. Therefore, the size of a memory transaction may be specified by multiplying the sum of one and the burst length of the burst-length line 202 by the size bits of the beat-size line 204 as shifted left by one bit.

In one implementation, the burst-length value register 212 and its corresponding burst-length mask register 222 for a pattern 125, in conjunction with the beat-size value register 214 and its corresponding beat-size mask register 224 for the pattern 125, define a size attribute of the pattern 125 (i.e., the size of data accessed at the range of memory addresses specified by the pattern 125). For a memory transaction on the memory bus 110 to match the pattern 125, the transaction has to specify a size attribute on the lines 202 and 204 that matches the size attribute of the corresponding value register 212-mask register 222 pair and the corresponding value register 214-mask register 224 pair. In another implementation, just the beat-size value register 214 and its corresponding beat-size mask register 224 may define the size attribute of a pattern 125.

The identifier line 206 is a multiple-bit line corresponding to an address identifier of one of multiple streams within a given channel in the AXI protocol, and thus specifies an identifier attribute of a memory transaction. The identifier line 206 may also be referred to as an AWID line in the case in which the memory bus 110 is a write bus, and an ARID line in the case in which the bus 110 is a read bus. The stream identifier may be used to identify the processor core of the processor 106 that is issuing a transaction on the memory bus 110, where each core has a corresponding identifier.

The identifier value register 216 and the identifier mask register 226 for a pattern 125 thus define an identifier attribute of the pattern 125, such as a processor identifier. For a memory transaction on the memory bus 110 to match the pattern 125, the transaction has to specify an identifier attribute on the identifier line 206 that matches the identifier attribute of the corresponding value register 216-mask register 226 pair.

The protection line 208 is a multiple-bit line corresponding to protection type in the AXI protocol, and thus specifies a protection identifier of a memory transaction. The protection type may have 3 bits respectively corresponding to privilege protection, security level protection, and data/instruction access protection per the AXI protocol. The protection line 208 may also be referred to as an AWPROT line in the case in which the memory bus 110 is a write bus, and an ARPROT line in the case in which the memory bus 110 is a read bus.

The protection value register 218 and the protection mask register 228 for a pattern 125 thus define a protection attribute of the pattern 125 (i.e., the protection type of the access of the range of memory addresses specified by the pattern 125). For a memory transaction on the memory bus 110 to match the pattern 125, the transaction has to specify a protection attribute on the protection line 208 that matches the protection attribute of the corresponding value register 218-mask register 228 pair.

The attribute lines 114 depicted in FIG. 2A denote examples of memory transaction registers that can be inspected for memory transaction tracking purposes via corresponding attribute value registers 128 and attribute value mask registers 130 depicted in FIGS. 2B and 2C. More generally, however, any attributes of memory transactions can be inspected for memory transaction tracking. Such attributes can include other attributes specified by the AXI protocol, and other attributes altogether if a protocol other than the AXI protocol is employed for memory transactions.

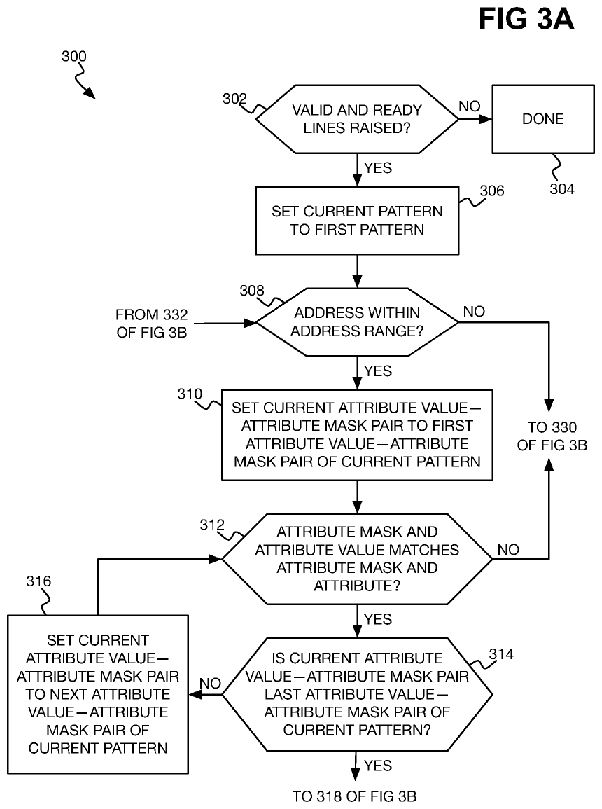

FIGS. 3A and 3B show an example method 300 that is performed by the secure circuitry 120 to track memory transactions on the memory bus 110, and thus to detect impermissible access of the memory 108 by the processor 106. The method 300 can be implemented as program code stored on a non-transitory computer-readable data storage medium and executable by a processor. For instance, the secure circuitry 120 may be implemented as a general-purpose processor, in which case the medium and the processor are separate discrete components of the circuitry 120. As another example, the secure circuitry 120 may be implemented as a specific-purpose processor, in which case the medium and the processor may be integrated within the circuitry 120 as an ASIC.

If the valid and ready lines 116 and 118 have not both been raised (302), then the method 300 is finished and does not proceed (304). As noted, when the ready line 118 has been raised, the processor 106 issues a memory transaction on the memory bus 110 and raises the valid line 116. Therefore, if both the valid and ready lines 116 and 118 are not raised (i.e., have not been set high), then the lines 112 and 114 of the bus 110 do not correspond to, represent, or indicate a valid memory transaction.

Assuming that a valid memory transaction has been issued on the memory bus 110, the secure circuitry 120 sets a current pattern to the first pattern 125 (306). If the memory address on the address lines 112 is within (i.e., inside) the memory address range specified by the address range register 126 for the current pattern (308), then the memory transaction on the bus 110 potentially matches the current pattern. Therefore, the secure circuitry 120 has to verify that the attribute specified by each attribute line 114 matches the attribute specified by the corresponding attribute value register 128-attribute mask register 130 pair of the current pattern.

Specifically, the secure circuitry 120 sets a current attribute value-attribute mask pair to the first such pair specified by the first attribute value register 128-attribute mask register 130 pair of the current pattern (310). In an implementation in which logical AND matching is employed, the secure circuitry 120 then determines whether the logical AND of the attribute mask and the attribute value of the current pair matches the logical AND of the attribute mask of the current pair and the corresponding attribute of the memory transaction on the memory bus 110 (312). That is, the logical AND of the specified attribute bits of the register 128 corresponding to the current pair and the mask of the register 130 corresponding to the current pair is compared to the logical AND of the attribute bits of the corresponding attribute line 114 and the mask. (As noted, in other implementations, other types of logic matching or another technique to determine whether the attribute specified by an attribute line 114 matches the attributed specified by the corresponding attribute value register 128-attribute mask register 130 pair.)

If the results of the two logical AND operations for the current attribute line 114 match (i.e., are identical or are equal to one another), then the secure circuitry 120 proceeds to verify whether the attribute of the next (if any) attribute line 114 matches the attribute specified by the corresponding attribute value register 128-attribute mask register 130 pair of the current pattern. Therefore, if the current attribute value-attribute mask pair is not the last such pair of the current pattern (314), then the secure circuitry 120 sets the current pair to the next attribute value-attribute mask pair of the current pattern (316), and repeats the method 300 at part 312. That is, the secure circuitry 120 sets the current pair to the attribute value-attribute mask pair specified by the next attribute value register 128-attribute mask register 130 pair of the current pattern.

Assuming that every attribute of the memory transaction on the memory bus 110 match the corresponding attribute of the current pattern, the secure circuitry 120 proceeds to increment the number of transactions matching the current pattern (318). That is, the transaction number register 132 for the current pattern is increased by one. Similarly, the secure circuitry 120 increases the cumulative size of the transactions matching the current pattern by the size of the memory transaction on the bus 110 (320). That is, size of the memory transaction is added to the transaction size register 134 for the current pattern.

The secure circuitry 120 then determines whether the number of transactions matching the current pattern exceeds the maximum permitted or expected number of transactions and whether the cumulative size of these transactions exceeded the maximum permitted or expected size. Specifically, if the number of transactions is greater than the maximum number of transactions specified by the maximum transaction number register 136 (322), then the secure circuitry 120 raises the corresponding bit within the number alert register 140 and masks the register 140 with the number alert mask of the number alert mask register 144 (324). Similarly, if the cumulative size of the transactions is greater than the maximum size specified by the maximum transaction size register 138 (326), then the secure circuitry 120 raises the corresponding bit within the size alert register 142 and masks the register 142 with the size alert mask of the size alert mask register 146 (328).

An alert bit of the number alert register 140 corresponding to the current pattern is thus set to one (i.e., high) responsive to the current number of matching transactions being greater than the maximum permitted or expected number of transactions for the current pattern. However, if the corresponding masking bit of the number alert mask register 144 is also not set to one, then the masking of the register 140 with the register 144 will result in the alert bit in question still being zero within the number alert register 140. That is, the corresponding masking bit of the alert mask register 144 is set to one to indicate that number alerts are to be triggered for the current pattern, and is set to zero to indicate that such alerts are not to be triggered. Therefore, even if the alert bit for the current pattern is set to one within the alert register 140, if the corresponding masking bit of the mask register 144 is set to zero, then the alert bit of the register 140 as masked will remain zero. This also applies to size alert register 140 vis-à-vis the size alert mask register 146.

If the current pattern is not the last pattern 125 (330), then the secure circuitry 120 advances the current pattern to the next pattern (332), and repeats the method 300 at part 308, to determine whether the memory transaction on the memory bus 110 matches this pattern. It is noted that if the address of the memory transaction is not within the address range of the current pattern (308), then the secure circuitry 120 does not inspect whether the attributes of the transaction match the attributes specified by the current pattern, and instead immediately proceeds to part 330 of the method 300. Similarly, if at any point the secure circuitry 120 determines that an attribute of the transaction does not match the corresponding attribute specified by the current pattern (312), the secure circuitry 120 immediately proceeds to part 330. Once the secure circuitry 120 has reached the last pattern (330), then the method 300 is finished (334).

The described method 300 can be implemented in practice in ways other than that shown in FIGS. 3A and 3B. In another implementation, for instance, the method 300 may operate as follows. The signals on the lines 112, 114, 116, and 118 of the memory bus 110 may be captured every clock cycle. The determination as to whether the address on the address line 112 falls within the address range specified by the address register 128 (i.e., per part 308), and the determination as to whether the attributes specified on the attribute lines 114 match the attributes of the patterns 125 as specified by the registers 128 and 130 (i.e., per part 312 for every register 128-register 130 pair of each pattern 125) may continuously occur. Then, if the valid and ready lines 116 and 118 are both raised high (i.e., per part 302), the transaction number register 132 is incremented (i.e., per part 318), and current transaction size is also calculated (e.g., based on the registers 202 and 204) and added to the transaction size register 134 (i.e., per part 320), for each pattern 125 that the transaction on the lines 112 and 114 matches.

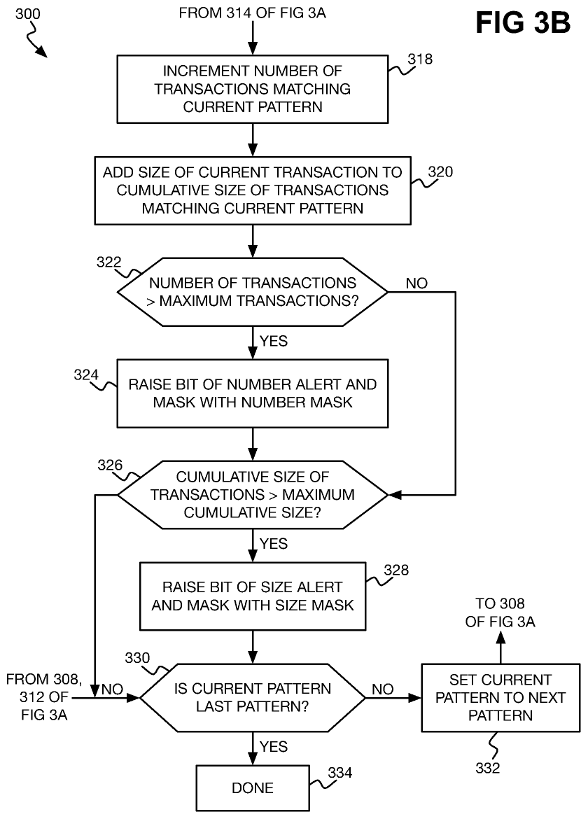

FIG. 4 shows an example non-transitory computer-readable data storage medium 400 storing program code 401 executable by the secure circuitry 120 of the IC 102 to perform processing. The processing includes tracking the number of memory transactions matching a specified pattern on a bus 110 between a processor 106 external to the secure circuitry 120 and a memory 108 external to the secure circuitry 120 (402). The processing includes tracking a cumulative size of the memory transactions matching the specified pattern on the bus 110 between the processor 106 and the memory 108 (404).

The processing includes, if the number of memory transactions matching the specified pattern is greater than a maximum permitted or expected number of such matching transactions (i.e., if the number of matching transactions is outside a number range for the specified pattern), performing a first action (406). The number of matching transactions being outside the number range can indicate that the processor 106 is impermissibly accessing the memory 108. The first action may be the triggering of a number alert, or an action that resolves an issue causing the processor 106 to impermissibly access the memory 108, such as rebooting the computing device 100, or restarting, pausing, or terminating the application currently being executed by a processor of the device 100.

The processing includes, if the cumulative size of the memory transactions matching the specified pattern is greater than a maximum or permitted size of such matching transactions (i.e., if the cumulative size of the matching transactions is outside a size range for the specified pattern), performing a second action (408). The cumulative size of the matching transactions being outside the size range can also indicate that the processor 106 is impermissibly accessing the memory 108. The second action may be the triggering of a size alert, and thus a different action than the first action. The second action may instead resolve an issue causing the processor 106 to impermissibly access the memory 108, and which may be the same action as the first action.

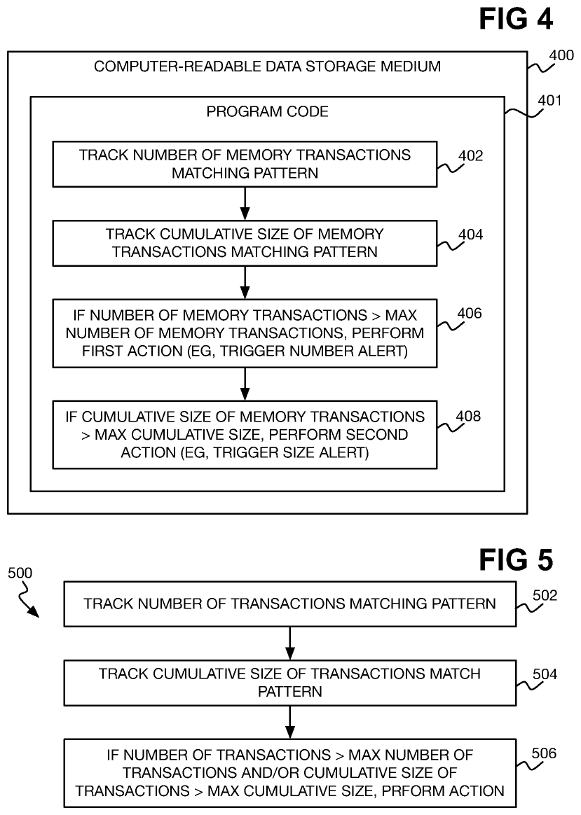

FIG. 5 shows an example method 500 that can be performed by the secure circuitry 120 of the IC 102. The method 500 includes detecting a number of memory transactions matching a specified pattern on a bus 110 between a processor 106 external to the secure circuitry 120 and a memory 108 external to the secure circuitry 120 (502). The method 500 includes detecting a cumulative size of the memory transactions matching the specified pattern on the bus 110 between the processor 106 and the memory 108 (504). The method 500 includes, in response to either or both of the number of the memory transactions being greater than a maximum transaction number (i.e., being outside a number range) and the cumulative size being greater than a maximum cumulative transaction size (i.e., being outside a size range), performing an action (506).

Techniques have been described for monitoring memory transactions on a memory bus 110 between a processor 106 and a memory 108. The number and cumulative size of the transactions that match each of a number of specified patterns are specifically tracked. Whether the processor 106 is impermissibly accessing the memory 108 can thus be detected, which may be indicative of a compromise in the security of the computing device 100 of which the processor 106 and the memory 108 are a part.

We claim:

1. A method comprising:
detecting, by secure circuitry, a number of memory transactions matching a specified pattern on a bus between a processor external to the secure circuitry and a memory external to the secure circuitry;
detecting, by the secure circuitry, a cumulative size of the memory transactions matching the specified pattern on the bus between the processor and the memory; and
in response to either or both of the number of the memory transactions being outside a number range and the cumulative size being outside a size range, performing, by the secure circuitry, an action.

2. The method of claim 1, wherein the number range corresponds to expected access of the memory by the processor as to the number of the memory transactions matching the specified pattern,
wherein the size range corresponds to expected access of the memory by the processor as to the cumulative size of the memory transactions matching the specified pattern,
and wherein either or both of the number of the memory transactions being outside the number range and the cumulative size being outside the size range indicates that the processor is impermissibly accessing the memory.

3. The method of claim 1, wherein the action resolves an issue causing the processor to impermissibly access the memory.

4. The method of claim 1, wherein the specified pattern indicates:
a range of memory addresses of the memory; and
attributes of access of the memory.

5. The method of claim 4, wherein the attributes of access of the range of memory addresses comprise:
an identifier of a stream corresponding to a core of the processor;
size of data accessed at the range of memory addresses; and
a protection type of the access of the range of memory addresses.

6. A non-transitory computer-readable data storage medium storing program code executable by secure circuitry to:
track a number of memory transactions matching a specified pattern on a bus between a processor external to the secure circuitry and a memory external to the secure circuitry; and
track a cumulative size of the memory transactions matching the specified pattern on the bus between the processor and the memory.

7. The non-transitory computer-readable data storage medium of claim 6, wherein the program code is executable by the processor to further:
in response to either or both of the number of the memory transactions being outside a number range and the cumulative size being outside a size range, performing, by the secure circuitry, to resolve an action an issue causing the processor to impermissibly access the memory.

8. The non-transitory computer-readable data storage medium of claim 6, wherein the program code is executable by the secure circuitry to track the number and the cumulative size of the memory transactions matching the specified pattern by, for each memory transaction:
determining whether a memory address of the memory transaction is inside a range of memory addresses of the specified pattern;
determining whether attributes of the memory transaction match attributes of the specified pattern; and
in response to determining that the memory address is inside the range of memory addresses and the attributes of the memory transaction match the attributes of the specified pattern, incrementing the number of the memory transactions matching the specified pattern and adding a size of the memory transaction to the cumulative size of the memory transactions matching the specified pattern.

9. The non-transitory computer-readable data storage medium of claim 8, wherein the number of the memory transactions matching the specified pattern is incremented and the size of the memory transaction is added to the cumulative size of the transactions matching the specified pattern in response to determining that the memory address is inside the range of memory addresses and the attributes of the memory transaction match the attributes of the specified pattern just if valid and ready handshake lines on the bus have both been raised.

10. The non-transitory computer-readable data storage medium of claim 8, wherein the bus comprises a multiple-bit burst-length line having a plurality of length bits corresponding to a burst length of the memory transaction and a multiple-bit beat-size line having a plurality of size bits corresponding to a beat size of the memory transaction,
and wherein the size of the memory transaction is added to the cumulative size of the memory transactions matching the specified pattern by multiplying a sum of one and the burst length by the size bits as shifted left by one bit.

11. The non-transitory computer-readable data storage medium of claim 8, wherein the bus comprises a plurality of multiple-bit attribute lines corresponding to different attributes of the memory transaction, each multiple-bit attribute line having a plurality of attribute bits,
wherein the specified pattern comprises, for each multiple-bit attribute line, specified attribute bits corresponding to the attribute bits and a specified bit mask,
and wherein whether the attributes of the memory transaction match the attributes of the specified pattern is determined by, for each multiple-bit attribute line, determining whether a logical AND operation of the specified bit mask and the attribute bits matches a logical AND operation of the specified bit mask and the specified attribute bits.

12. An integrated circuit comprising:
a bus interface to a bus between a processor external to the integrated circuit and memory external to the integrated circuit, over which access of the memory by the processor is monitored;
a monitoring interface on which alerts are triggered responsive to monitoring of the access of the memory by the processor; and
secure circuitry to:
track a number of memory transactions matching each of a plurality of specified patterns on the bus between the processor external to the secure circuitry and the memory external to the secure circuitry;
track a cumulative size of the memory transactions matching each specified pattern on the bus between the processor and the memory; and
for each specified pattern for which the number of the memory transactions is outside a number range, trigger a number alert; and
for each specified pattern for which the cumulative size of the memory transactions is outside a size range, trigger a size alert.

13. The integrated circuit of claim 12, wherein the bus comprises a plurality of multiple-bit attribute lines corresponding to different attributes of the memory transaction, each multiple-bit attribute line having a plurality of attribute bits,
wherein the specified pattern comprises, for each multiple-bit attribute line, specified attribute bits corresponding to the attribute bits and a specified bit mask,
and wherein the secure circuitry is to track the number and the cumulative size of the memory transactions matching each specified pattern by, for each memory transaction:
determining whether a memory address of the memory transaction is inside a range of memory addresses of the specified pattern;
for each multiple-bit attribute line, determining whether a logical AND operation of the specified bit mask and the attribute bits matches a logical AND operation of the specified bit mask and the specified attribute bits; and
in response to determining that the memory address is inside the range of memory addresses and, for each multiple-bit attribute line, the logical AND operation of the specified bit mask and the attribute bits matches the logical AND operation of the specified bit mask and the specified attribute bits, incrementing the number of the memory transactions matching the specified pattern and adding a size of the memory transaction to the cumulative size of the memory transactions matching the specified pattern.

14. The integrated circuit of claim 13, wherein the bus comprises a multiple-bit burst-length line having a plurality of length bits corresponding to a burst length of the memory transaction and a multiple-bit beat-size line having a plurality of size bits corresponding to a beat size of the memory transaction,
and wherein the size of the memory transaction is added to the cumulative size of the memory transactions matching the specified pattern by multiplying a sum of one and the burst length by the size bits as shifted left by one bit.

15. The integrated circuit of claim 14, wherein the number of the memory transactions matching the specified pattern is incremented and the size of the memory transaction is added to the cumulative size of the transactions matching the specified pattern in response to determining that the memory address is inside the range of memory addresses and, for each multiple-bit attribute line, the logical AND operation of the specified bit mask and the attribute bits matches the logical AND operation of the specified bit mask and the specified attribute bits just if valid and ready handshake lines on the bus have both been raised.
